(19) United States
(12) Patent Application Publication
(10) Pub. No.: US 2018/0342175 A1
(43) Pub. Date: Nov. 29, 2018

(54) Methods to Assessing Student Language Proficiency

(71) Applicant: Pharr-San Juan-Alamo Independent School District, Pharr, TX (US)

(72) Inventors: Haissam M. Mayasi, Weslaco, TX (US); Jose Adrian Garcia, McAllen, TX (US); Sergio Adrian Gonzalez, San Juan, TX (US); Claudio Enrique Cantu, Pharr, TX (US); John Alexander Reyes, Mercedes, TX (US)

(73) Assignee: Pharr-San Juan-Alamo Independent School District, Pharr, TX (US)

(21) Appl. No.: 15/990,061

(22) Filed: May 25, 2018

Related U.S. Application Data
(60) Provisional application No. 62/511,144, filed on May 25, 2017.

(51) Int. Cl. G09B 19/06; G09B 5/00

(52) U.S. Cl. CPC G09B 19/06; H04L 67/02; G09B 5/00

(57) ABSTRACT

Methods for identifying and assessing the language proficiency of a student with a web based interface package

### CROSS-REFERENCE TO RELATED APPLICATIONS

This application is a non-provisional application that claims the benefit of U.S. Provisional Application Ser. No. 62/511,144 filed on May 25, 2017, which is herein incorporated by reference in its entirety.

### BACKGROUND

Embodiments relate generally to methods for identifying and assessing the language proficiency of a student with a web based interface package. More particularly, embodiments relate to web based interface and methods for holding and storing document for review and assessment by students, parents, teachers, and language proficiency assessment committee.

Currently, students in classrooms where English is spoken may be at a disadvantage if English is not their first language. Administration may attempt to identify these students who are Limited English Proficient (LEP) and/or English as a Second Language (ESL). By assessing the language proficiencies of students, administration may be able to place students in a classroom setting that may benefit the students learning process. In many school districts, methods of identifying LEP and ESL students is carried out with hard copies of paper which may be stored in a folder. The folder is assigned to a student who maintains the folder for review by parents, teachers, and/or Language Proficiency Assessment Committee (LPAC). This may be problematic as the folder may become lost, papers from teachers and/or the LPAC may not be placed in the folder, papers may be lost, etc. A web based interface system may be implemented to remove the use of a folder. The web based interface system may also allow students, parents, teachers, and/or LPAC to access each and every document. A method may be implemented in which an LEP and/or ESL student is identified, given access to the web based interface, and assessment of the students learning is overseen by parents, teachers and/or LPAC. This method in conjunction with the web based software may allow parents, teachers, administrators and/or LPAC to review, assess, and guide a LEP and/or ESL student.

### BRIEF DESCRIPTION OF THE DRAWINGS

These drawings illustrate certain aspects of some of the embodiments of the present invention and should not be used to limit or define the invention.

FIG. 1 illustrates a flow chart of a method for assessing Limited English Proficient students;

FIGS. 2a and 2b illustrate a flow chart;

FIGS. 3a and 3b illustrate a flow chart;

FIG. 4 illustrates a flow chart; and

FIG. 5 illustrates a flow chart.

### DETAILED DESCRIPTION

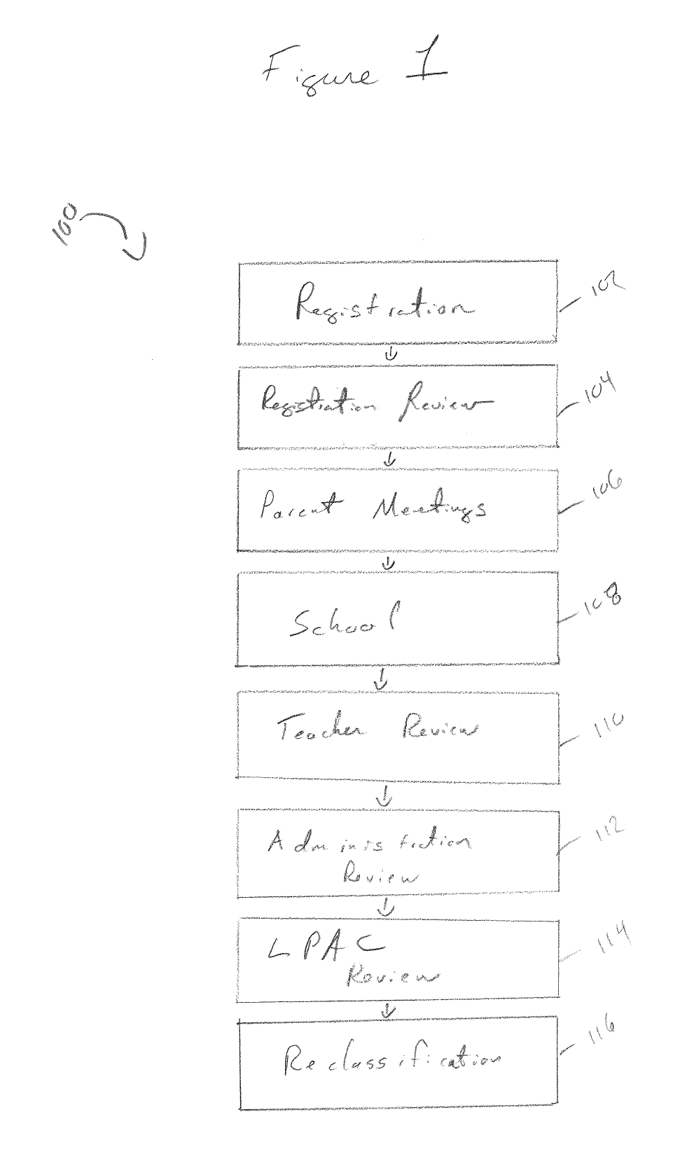

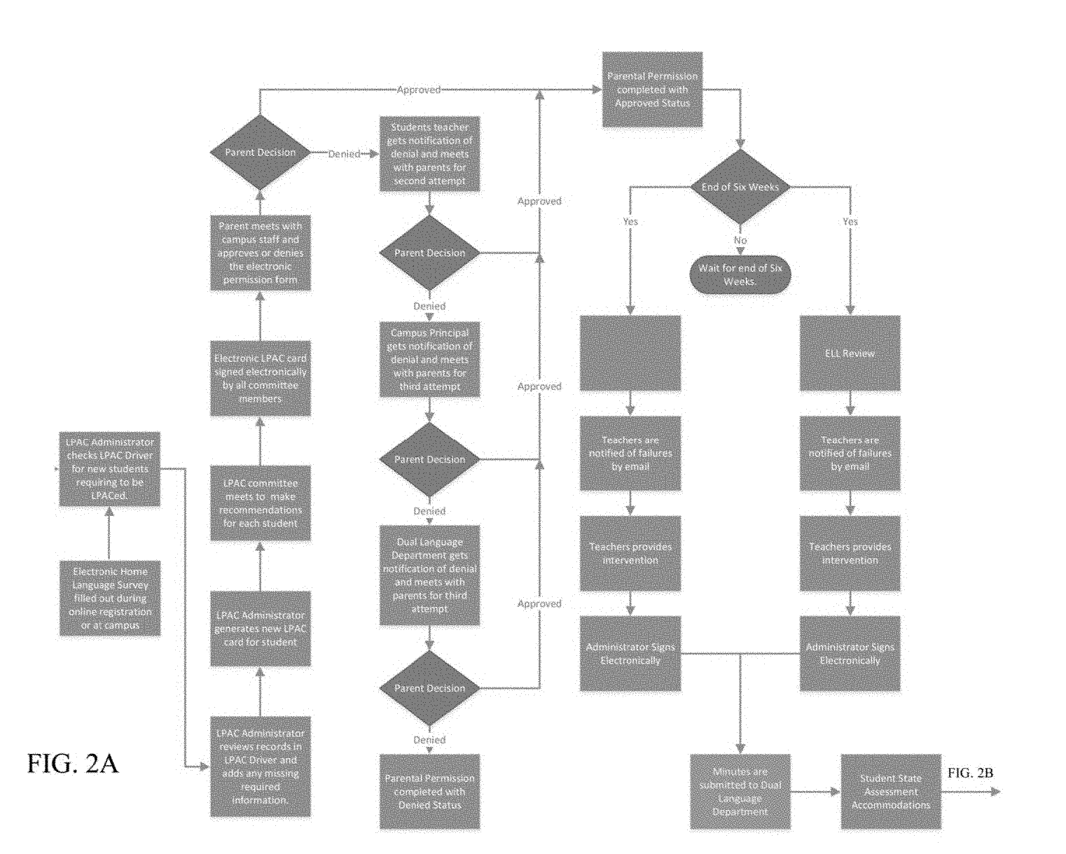

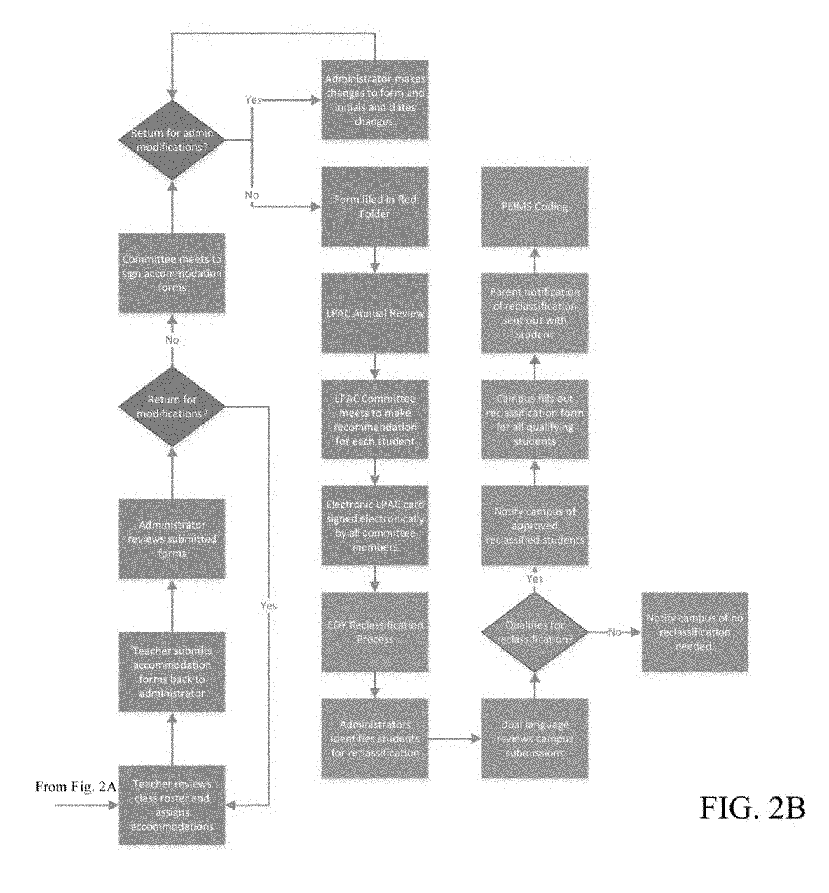

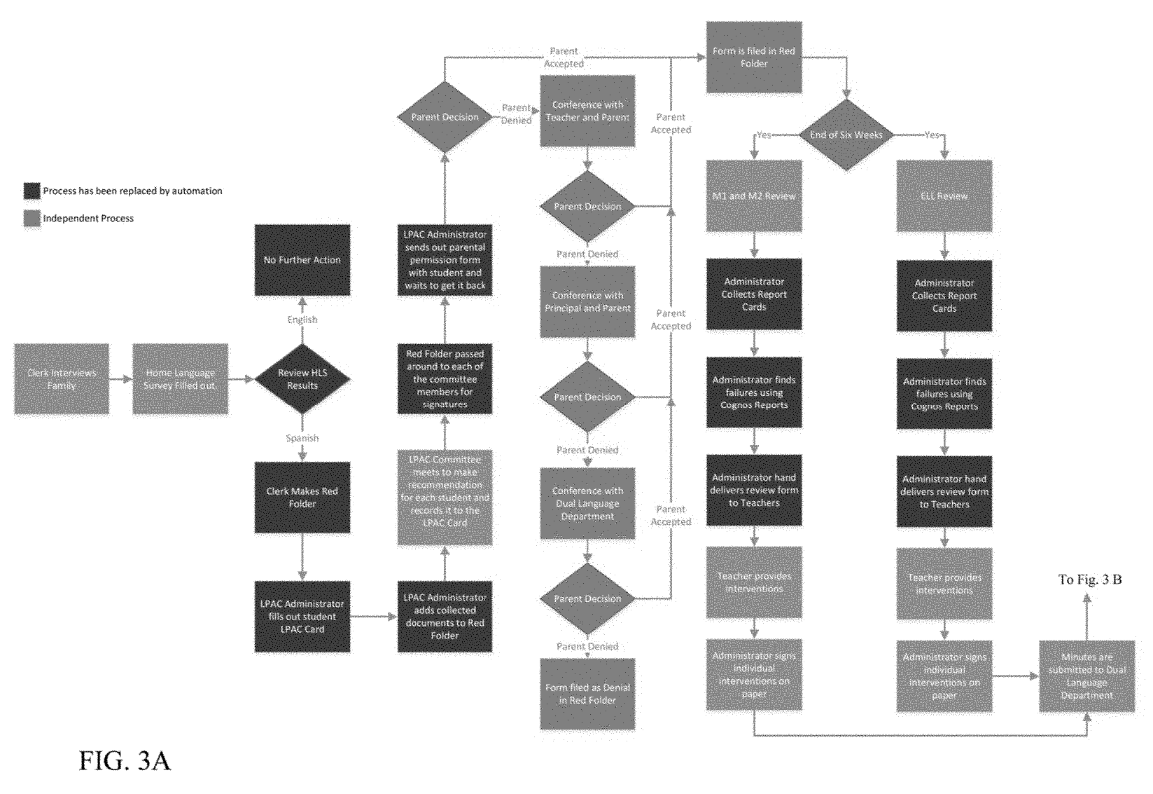

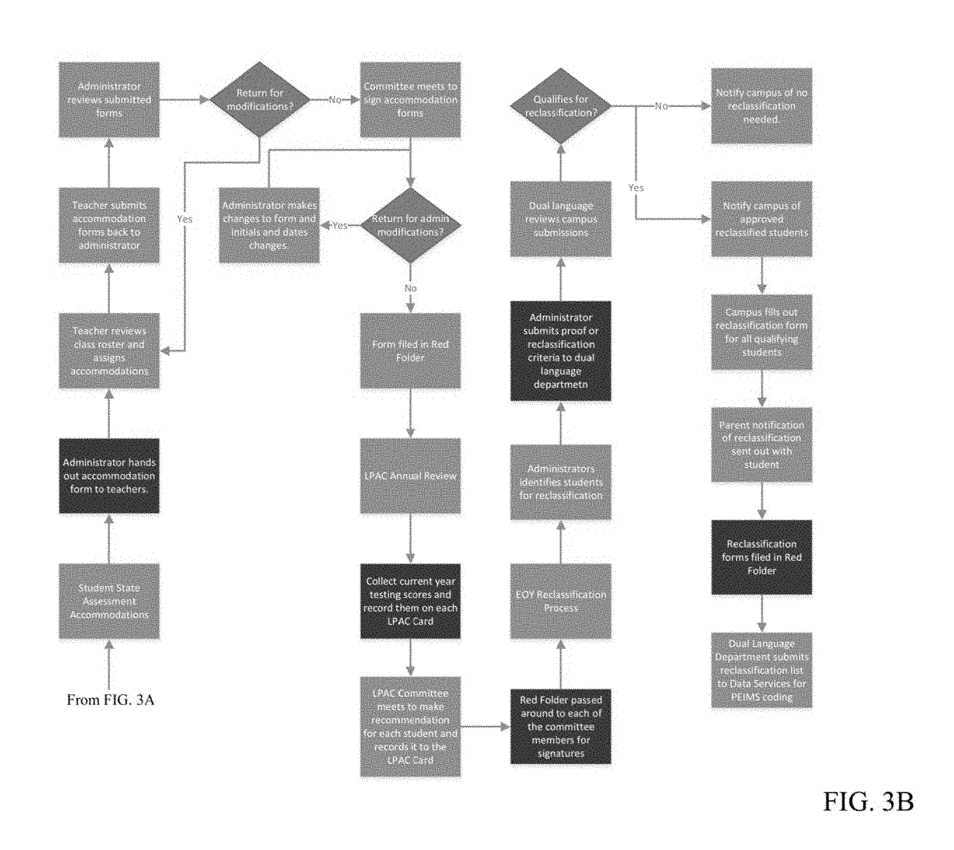

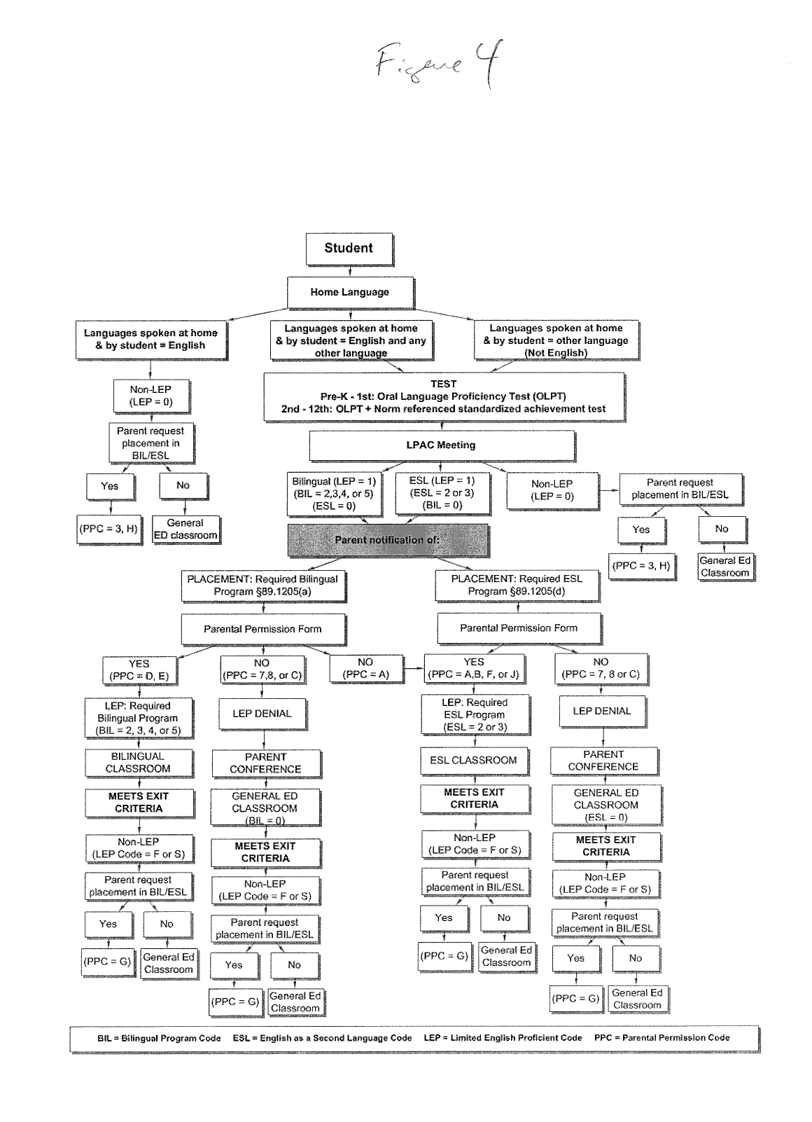

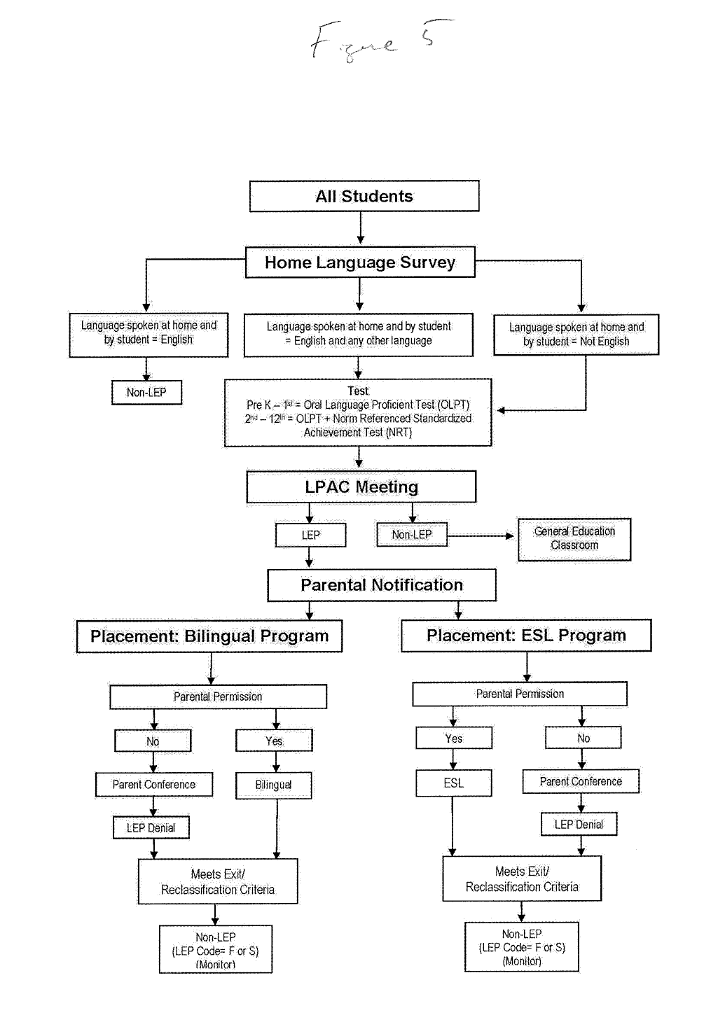

Embodiments relate generally to methods and web based interface for assessing a LEP and/or ESL student. More particularly, embodiments relate to methods that identify and assess an LEP and/or ESL student in school. FIG. 1 illustrates a flow chart 100 for identifying and assessing an LEP and/or ESL student in a school setting.

FIG. 1 illustrates flow chart 100, which may begin by identifying a prospective student. A prospective student may be identified through a home language survey, which may be given to the student on a web based interface or paper. From the home survey, a student may be identified as a LEP and/or ESL student. Identified, the prospective student may be instructed to perform the step of registration 102 on a web based interface to create a profile. The registration process may ask the student and/or their parents to fill out contact information such as an address and telephone number. Additionally, registration 102 may comprise a language survey, which may be completed by the student. This survey may form the foundation by which LPAC may determine a LEP and/or ESL student. It should be noted that LPAC may be defined as any committee, individual, and/or administrator tasked with identifying a LEP and/or ESL student.

Upon completion of registration 102, registration review 104 may be the next method step. During Registration review, an LPAC administrator reviews the survey, if filled out, of a LEP and/or ESL student on the web based browser. The LPAC driver may provide guidelines to the administrators at a school campus to determine what action may be taken to prepare the LEP and/or ESL student for school. Review of the LEP and/or ESL student's registration may also be performed to determine if further documents may be missing and/or may be required of the LEP and/or ESL student and parents. Upon review of the LEP and/or ESL student's documents on the web based browser, an identification card may be created for LEP and/or ESL student. This identification card may allow access to the web based interface and may digitally contain all of document submitted and/or filled out by the LEP and/or ESL student, parents, administrators, and/or LPAC. The LPAC may meet to make recommendations for the LEP and/or ESL student. Those recommendations may be placed on the identification card. In examples, recommendations may be stored on the web based interface under the student's profile. The identification card may then be signed, physically and/or electronically, by a member of the LPAC. Before a student, who may be identified as a LEP and/or ESL student, may participate in classrooms targeted toward a LEP and/or ESL student, the parents of the LEP and/or ESL student must approve.

After registration review 104, parent meetings 106 may be scheduled and performed to obtain the consent of the parent to allow their child to participate in classrooms targeted toward a LEP and/or ESL student. It should be noted that parents may also be defined as legal and/or court appointed guardians. Parents may meet with teachers and/or administrators to discuss this issue. If the parents agree to allow their child to participate in LEP and/or ESL student targeted classrooms, the student is placed into LEP and/or ESL classroom during school, which is identified as school 108. If the parents deny participation of their child in LEP and/or ESL classrooms, no less than one more attempt, through meetings with the parent, may be made to gain the parents approval. If the parents' consent is not obtained, the student may not be placed in LEP and/or ESL classrooms and the student's registration and access to the web based interface may be removed.

During school 108, any amount of time may be allowed before a teacher review 110 of the LEP and/or ESL student's progress may be performed. For example, an English Language Learner (“ELL”) review and/or a M1 and/or M2 Review may be performed. A M1 review may be defined as a first year of monitoring after the LEP and/or ESL student exists the program. A M2 review may be defined as a second year of monitoring after the LEP and/or ESL student exits the program. It should be noted that any other types of tests may be performed to determine the progress of the LEP and/or ESL student in school. The results may be loaded and/or stored on the web based interface. Teachers may be notified and/or access the web based interface to determine if the LEP and/or ESL student failed a prescribed test. If the LEP and/or ESL student has failed, the teacher may provide additional time and education tool to help the LEP and/or ESL student in the classroom. After the teacher has stepped in to assist the LEP and/or ESL student, an administrator and/or teacher may sign off on the web based interface that the teacher has in fact taken appropriate measure with the LEPO and/or ESL student. This assistance may then be submitted to the next step of an administration review 112. If the LEP and/or ESL student did not fail, the LEP and/or ESL student may proceed to reclassification, discussed below.

During administration review 112, the assistance provided by the teacher, and stored on the web based interface, may be accessed on the web based interface to perform an accommodation assessment. In administration review 112, an administrator may sign off on the assistance and accommodations provided by the teacher. Administrators may sign off on the web based interface. Accommodations may be prescribed and submitted to teachers who teach the LEP and/or ESL student. Accommodations and class rosters may be reviewed by the teachers for input. For example, the teacher may log on to the web based interface and access the LEP and/or ESL student's profile and submit accommodations specifically for the LEP and/or ESL student. These accommodations submitted by the teachers may be reviewed by an administrator. In examples the administrator may request the teachers to review and submit new accommodations. Newly submitted accommodations may be reviewed and either accepted and/or rejected by the administrator. This process may be performed on the web based interface with the teachers and administrators accessing the profile of the LEP and/or ESL student. After approval of accommodations by the administrator, the accommodations may be finalized and approved by LPAC. LPAC may access the accommodation request on the web based interface. If the accommodations are approved, the LPAC may update the web base profile of the LEP and/or ESL student to reflect the accommodations, which may be accessed by teachers. If the accommodations are rejected by the LPAC, new accommodations may be recommended by the LPAC, which may be signed off on by the administrator and dated.

Upon completion of administration review 112, a LPAC review 114 may be commenced to review the LEP and/or ESL student's progress over the school year. This review may be performed annually (up to two years after the student exits the program) and/or any suitable time designated by the LPAC. During LPAC review 114, additional recommendations may be presented, discussed, and/or accepted to assist the LEP and/or ESL student. Accepted recommendations may be uploaded to the LEP and/or ESL student's identification card and/or the web based interface, which may be accessed by the student, parents, and/or administrators. At the end of LPAC review 114, the LEP and/or ESL student may be identified for reclassification 116.

Reclassification 116 may be begin with an end of year (“EOY”) reclassification process. This process may comprise, criteria set forth by a governing body (i.e. Federal, State, and/or local governments). The results of the EOY reclassification process may be performed, uploaded, accessed, and/or stored on the web based interface. Administrators may use the EOY process to identify the LEP and/or ESL student that may need to be reclassified. A dual language review submission may be performed by the student on the web based interface and/or at a school. The results may help further determine if the LEP and/or ESL student qualifies for reclassification. If the LEP and/or ESL student does not qualify for reclassification, the LEP and/or ESL student's teachers, administrators, and/or school may be notified that no reclassification occurred. If the LEP and/or ESL student qualifies for reclassification, the LEP and/or ESL student's teachers, administrators, and/or school may be notified that no reclassification occurred. If reclassification occurs, administrators and/or teachers at the school of the LEP and/or ESL student fill out a reclassification form. In examples, the reclassification form may be filled out on the web based interface on the LEP and/or ESL student's profile. Upon reclassification, a notice may be sent to the parents of the LEP and/or ESL student through mail, the student, and/or accessed by the parents on the web based interface. The LEP and/or ESL student may continue with school and be reviewed and/or reclassified until the LEP and/or ESL student may not need to attend classes for LEP and/or ESL students.

During this process, all information, progress, notes, accommodation, teacher recommendations, administrator recommendations, and/or the like may be reported on the public education information management system (“PEIMS”). PEIMS may allow a school, administrator, and/or teacher to report the progress of an LEP and/or ESL student's progress to a governing body (i.e. Federal, State, and/or Local government). In embodiments, PEIMS may be a web based interface, software, and/or paper filings.

The foregoing figures and discussion are not intended to include all features of the present techniques to accommodate a buyer or seller, or to describe the system, nor is such figures and discussion limiting but exemplary and in the spirit of the present techniques.

What is claimed is:

1. A method for assessing the language proficiency of a student comprising:
registering a student on a web based interface;
registration review by an administrator;
meeting with the parents;
assessing the student's progress in school by a teacher;
administrative review of the assessing the student's progress;
review by a language proficiency assessment committee; and
reclassification of the student.
